(19) United States
(12) Patent Application Publication
(10) Pub. No.: US 2021/0215113 A1
(43) Pub. Date: Jul. 15, 2021

(54) CATALYST DETERIORATION JUDGING DEVICE FOR INTERNAL COMBUSTION ENGINE

(71) Applicant: TOYOTA JIDOSHA KABUSHIKI KAISHA, Aichi-ken (JP)

(72) Inventor: Tsuyoshi OBUCHI, Susono-shi (JP)

(21) Appl. No.: 17/124,501

(22) Filed: Dec. 17, 2020

(30) Foreign Application Priority Data
Jan. 15, 2020 (JP) 2020-004531

(51) Int. Cl. F02D 41/14; F01N 11/00

(52) U.S. Cl. CPC F02D 41/1441; F01N 13/009; F01N 11/007

(57) ABSTRACT

In order to detect the degree of deterioration of one catalyst with a simple configuration, a catalyst deterioration judging device for an internal combustion engine includes an upstream catalyst disposed in an engine exhaust passage, a downstream catalyst disposed in the engine exhaust passage downstream of the upstream catalyst, an inflow air-fuel ratio sensor for detecting the air-fuel ratio of an inflow exhaust gas to the upstream catalyst, an outflow air-fuel ratio sensor for detecting the air-fuel ratio of an outflow exhaust gas from the downstream catalyst, and an electronic control unit. The maximum oxygen storage amount of the upstream catalyst is detected based on the output of the inflow air-fuel ratio sensor and the output of the outflow air-fuel ratio sensor when the upstream catalyst is in the active state and the downstream catalyst is in the inactive state.

### FIELD

The present disclosure relates to a catalyst deterioration judging device of an internal combustion engine.

### BACKGROUND

An internal combustion engine is known which is provided with a casing disposed in an engine exhaust passage, an upstream catalyst housed in an upstream side of the casing, and a downstream catalyst housed in a downstream side of the casing (refer to, for example, PTL 1). In PTL 1, the upstream catalyst is composed of an electrically-heated catalyst, and the downstream catalyst is composed of a three-way catalyst.

A catalyst deterioration degree detecting device for an internal combustion engine is also known which is provided with a casing disposed in an engine exhaust passage, a catalyst housed in the casing and having an oxygen storage capacity, an inflow air-fuel ratio sensor for detecting the air-fuel ratio of an inflow exhaust gas to the catalyst, and an outflow air-fuel ratio sensor for detecting the air-fuel ratio of an outflow exhaust gas from the catalyst, and which detects, based on the output of the inflow air-fuel ratio sensor and the output of the outflow air-fuel ratio sensor, the maximum oxygen storage amount of the catalyst representing the degree of deterioration of the catalyst.

### CITATION LIST

### Patent Literature

[PTL 1] Japanese Unexamined Patent Publication No. H10 (1998)-184344

### SUMMARY

### Technical Problem

If the above-described catalyst deterioration degree detecting device is applied to the internal combustion engine of PTL 1, the sum of the maximum oxygen storage amount of the upstream catalyst and the maximum oxygen storage amount of the downstream catalyst is detected. However, it is not possible to individually detect the maximum oxygen storage amounts of the upstream catalyst and the maximum oxygen storage amount of the downstream catalyst. In other words, it is not possible to individually detect the degree of deterioration of the upstream catalyst and the degree of deterioration of the downstream catalyst, and it is not possible to detect the degree of deterioration of the upstream catalyst.

In this regard, if an additional air-fuel ratio sensor is provided between the upstream catalyst and the downstream catalyst, the degree of deterioration of the upstream catalyst can be detected based on the output of the inflow air-fuel ratio sensor and the output of the additional air-fuel ratio sensor. Further, the degree of deterioration of the downstream catalyst can be detected based on the output of the additional air-fuel ratio sensor and the output of the outflow air-fuel ratio sensor. However, the provision of additional air-fuel ratio sensors increases the number of components and increases the cost.

### Solution to Problem

According to the present disclosure, there are provided:

### [Configuration 1]

A catalyst deterioration judging device for an internal combustion engine, comprising:
a catalyst including a first catalyst and a second catalyst arranged in series in an engine exhaust passage;
an inflow exhaust gas detector configured to detect a state quantity of an inflow exhaust gas to the catalyst;
an outflow exhaust gas detector configured to detect a state quantity of an outflow exhaust gas from the catalyst; and
an electronic control unit configured to detect a degree of deterioration of the first catalyst based on an output of the inflow exhaust gas detector and an output of the outflow exhaust gas detector when the first catalyst is in an active state and the second catalyst is in an inactive state.

### [Configuration 2]

The catalyst deterioration judging device for an internal combustion engine according to configuration 1, wherein
the first catalyst is comprised of a catalyst that can be activated when the internal combustion engine is stopped, and
the electronic control unit is further configured to activate the first catalyst while maintaining the internal combustion engine stopped, to thereby make the first catalyst in the active state and the second catalyst in the inactive state.

### [Configuration 3]

The catalyst deterioration judging device for an internal combustion engine according to configuration 1 or 2, wherein
the first catalyst is comprised of an electrically heated catalyst, and
the electronic control unit is further configured to energize the first catalyst while maintaining the internal combustion engine stopped, to thereby make the first catalyst in the active state and the second catalyst in the inactive state.

### [Configuration 4]

The catalyst deterioration judging device for an internal combustion engine according to any one of configurations 1 to 3, wherein
the first catalyst has an oxygen storage capacity,
the inflow exhaust gas detector is configured to detect an air-fuel ratio of the inflow exhaust gas, and
the outflow exhaust gas detector is configured to detect an air-fuel ratio of the outflow exhaust gas.

### [Configuration 5]

The catalyst deterioration judging device for an internal combustion engine according to any one of configurations 1 to 4, wherein
the electronic control unit is further configured to:
   detect the degree of deterioration of the catalyst as a whole based on the output of the inflow exhaust gas detector and the output of the outflow exhaust gas detector when the first catalyst is in the active state and the second catalyst is in the active state; and
   detect the degree of deterioration of the second catalyst based on the degree of deterioration of the first catalyst and the degree of deterioration of the catalyst as a whole.

### [Configuration 6]

The catalyst deterioration judging device for an internal combustion engine according to configuration 5, wherein
the first catalyst is comprised of a catalyst that can be activated when the internal combustion engine is stopped, and
the electronic control unit is further configured to activate the first catalyst while maintaining the internal combustion engine stopped, to thereby make the first catalyst in the active state and the second catalyst in the inactive state.

### [Configuration 7]

The catalyst deterioration judging device for an internal combustion engine according to configuration 5 or 6, wherein
the first catalyst is comprised of an electrically heated catalyst, and
the electronic control unit is further configured to:
   energize the first catalyst while maintaining the internal combustion engine stopped, to thereby make the first catalyst in the active state and the second catalyst in the inactive state; and
   operate the internal combustion engine, to thereby make the first catalyst in the active state and the second catalyst in an active state.

### [Configuration 8]

The catalyst deterioration judging device for an internal combustion engine according to any one of configurations 5 to 7, wherein
the first catalyst and the second catalyst have an oxygen storage capacity,
the inflow exhaust gas detector is configured to detect an air-fuel ratio of the inflow exhaust gas, and
the outflow exhaust gas detector is configured to detect an air-fuel ratio of the outflow exhaust gas.

### [Configuration 9]

The catalyst deterioration judging device for an internal combustion engine according to any one of configurations 1 to 8, wherein the first catalyst is disposed on an upstream side in an exhaust gas flow direction, and the second catalyst is disposed on a downstream side in the exhaust gas flow direction.

### [Configuration 10]

The catalyst deterioration judging device for an internal combustion engine according to any one of configurations 1 to 9, wherein the electronic control unit is further configured, when the operation of the internal combustion engine is to be started, to first activate the first catalyst while maintaining the internal combustion engine stopped, and then start the operation of the internal combustion engine after the first catalyst is activated.

### [Configuration 11]

A catalyst deterioration judging method of an internal combustion engine which is provided with a catalyst including a first catalyst and a second catalyst arranged in series in an engine exhaust passage, the catalyst deterioration judging method comprising:
detecting a state quantity of an inflow exhaust gas flowing into the catalyst;
detecting a state quantity of an outflow exhaust gas flowing out from the catalyst; and
detecting a degree of deterioration of the first catalyst based on the state quantity of the inflow exhaust gas and the state quantity of the outflow exhaust gas when the first catalyst is in an active state and the second catalyst is in an inactive state.

### [Configuration 12]

The catalyst deterioration judging method of an internal combustion engine according to configuration 11, wherein
the first catalyst is comprised of a catalyst that can be activated when the internal combustion engine is stopped, and
the method comprises activating the first catalyst while maintaining the internal combustion engine stopped, to thereby make the first catalyst in the active state and the second catalyst in the inactive state.

### [Configuration 13]

The catalyst deterioration judging method of an internal combustion engine according to configuration 11 or 12, wherein
the first catalyst is comprised of an electrically heated catalyst, and
the method comprises energizing the first catalyst while maintaining the internal combustion engine stopped, to thereby make the first catalyst in the active state and the second catalyst in the inactive state.

### [Configuration 14]

The catalyst deterioration judging method of an internal combustion engine according to any one of configurations 11 to 13, comprising:
detecting the degree of deterioration of the catalyst as a whole based on the state quantity of the inflow exhaust gas and the state quantity of the outflow exhaust gas when the first catalyst is in the active state and the second catalyst is in the active state; and
detecting the degree of deterioration of the second catalyst based on the degree of deterioration of the first catalyst and the degree of deterioration of the catalyst as a whole.

### Advantageous Effects of Invention

The degree of deterioration of one catalyst can be detected with a simple configuration.

### BRIEF DESCRIPTION OF DRAWINGS

FIG. 1 is a schematic overall view of a hybrid vehicle according to an embodiment of the present disclosure.

FIG. 2 is a time chart for explaining the engine start control of the embodiment according to the present disclosure.

FIG. 3 is a time chart for explaining the catalyst deterioration degree detection of the embodiment according to the present disclosure.

FIG. 4 is a flowchart for executing an engine start control routine of the embodiment according to the present disclosure.

FIG. 5 is a flowchart for executing the catalyst deterioration determination routine of the catalyst of the embodiment according to the present disclosure.

FIG. 6 is a flowchart for executing the catalyst deterioration determination routine of the catalyst of the embodiment according to the present disclosure.

FIG. 7 is a flowchart for executing the catalyst deterioration determination routine of the catalyst of the embodiment according to the present disclosure.

### DESCRIPTION OF EMBODIMENTS

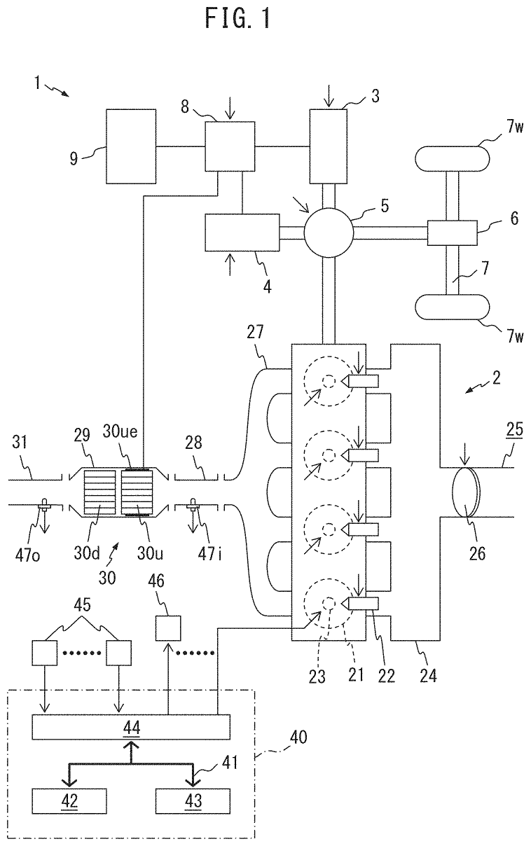

Referring to FIG. 1, a vehicle 1 of an embodiment according to the present disclosure is composed of a hybrid vehicle comprising an electric motor and an internal combustion engine. In another embodiment (not shown), the vehicle 1 is composed of a vehicle comprising an internal combustion engine without an electric motor. The hybrid vehicle 1 of the embodiment according to the present disclosure comprises an internal combustion engine 2, an electric motor or first motor generator 3, a generator or second motor generator 4, a power dividing mechanism 5, a speed reducer 6, an axle 7 comprising wheels 7w, a power control unit 8, a battery 9, and an electronic control unit 40. The internal combustion engine 2 of the embodiment according to the present disclosure is composed of a spark-ignition engine. In another embodiment (not shown), the internal combustion engine 2 is composed of a compression-ignition engine.

The internal combustion engine 2 of the embodiment according to the present disclosure includes a plurality of cylinders 21. The cylinders 21 of the embodiment according to the present disclosure each comprise a fuel injection valve 22 and a spark plug 23 for combustion in a combustion chamber. Further, the cylinders 21 are connected to an intake duct 25 via a surge tank 24, and a throttle valve of an electronic control type 26 is disposed in the intake duct 25. The cylinders 21 are further coupled to a casing 29 via an exhaust manifold 27 and an exhaust pipe 28. A catalyst 30 is housed in the casing 29. The catalyst 30 of the embodiment according to the present disclosure includes an upstream catalyst 30u located on the upstream side in the exhaust gas flow direction and a downstream catalyst 30d located on the downstream side in the exhaust gas flow direction. In other words, the upstream catalyst 30u and the downstream catalyst 30d are accommodated in the casing 29 while being arranged in series in the exhaust gas flow direction. The upstream catalyst 30u and the downstream catalyst 30d of the embodiment according to the present disclosure are each composed of, for example, a three-way catalyst or an oxidation catalyst. As shown in FIG. 1, the upstream catalyst 30u and the downstream catalyst 30d of the embodiment according to the present disclosure are separated from each other in the exhaust gas flow direction. In another example (not shown), the upstream catalyst 30u and the downstream catalyst 30d are each accommodated in a separate casing. The casing 29 is connected to an underfloor catalyst (not shown) via an exhaust pipe 31.

Each of the upstream catalyst 30u and the downstream catalyst 30d of the embodiment according to the present disclosure has an oxygen storage capacity. In one example, the upstream catalyst 30u and the downstream catalyst 30d each comprise cerium oxide. Specifically, when the upstream catalyst 30u and the downstream catalyst 30d are in an active state, if the air-fuel ratio of the inflowing exhaust gas is leaner than the stoichiometric air-fuel ratio, oxygen in the exhaust gas is combined with cerium oxide and stored in the upstream catalyst 30u and the downstream catalyst 30d. Conversely, when the air-fuel ratio of the inflowing exhaust gas becomes richer than the stoichiometric air-fuel ratio, the stored oxygen is detached from the cerium oxide and released from the upstream catalyst 30u and the downstream catalyst 30d. The released oxygen is used to oxidize HC, CO, etc. in the exhaust gas. When the upstream catalyst 30u and the downstream catalyst 30d are in an inactive state, little oxygen is stored in the upstream catalyst 30u and the downstream catalyst 30d, or little oxygen is released from the upstream catalyst 30u and the downstream catalyst 30d.

In an embodiment according to the present disclosure, the internal combustion engine 2 and the electric motor 3 are mechanically coupled to the power dividing mechanism 5, and the power dividing mechanism 5 is mechanically coupled to the axle 7 via the speed reducer 6. The generator 4 is also mechanically coupled to the power dividing mechanism 5. The power dividing mechanism 5 includes, for example, a planetary gear mechanism. The output of the internal combustion engine 2 is transmitted to one or both of the axle 7 and the generator 4 by the power dividing mechanism 5. The output of the electric motor 3 is transmitted to one or both of the axle 7 and the internal combustion engine 2 by the power dividing mechanism 5. In the embodiment according to the present disclosure, when it is necessary to drive the hybrid vehicle 1, the electric motor 3 is driven while the internal combustion engine 2 is stopped such that only the output of the electric motor 3 is transmitted to the axle 7 (EV operation), or the internal combustion engine 2 and the electric motor 3 are operated such that the outputs of the internal combustion engine 2 and the electric motor 3 are transmitted to the axle 7 (HV operation).

In the embodiment according to the present disclosure, when the SOC (state of charge) of the battery 9 is equal to or higher than a predetermined operation switching value, the electric motor 3 is operated while the internal combustion engine 2 is stopped, and when the SOC of the battery 9 is lower than the operation switching value, the operation of the internal combustion engine 2 is started while the operation of the electric motor 3 is continued. Further, in the embodiment according to the present disclosure, when the SOC of the battery 9 is less than or equal to a charge request value smaller than the operation switching value, the internal combustion engine 2 is operated to drive the generator 4, and the battery 9 is charged with electric power generated by the generator 4. Further, in embodiments according to the present disclosure, when the internal combustion engine 2 is required to be motor-driven (motoring), the electric motor 3 is operated and the output of the electric motor 3 is transmitted to the internal combustion engine 2. Note that the electric motor 3 of the embodiment according to the present disclosure is driven by the axle 7 to operate as a generator at, for example, the time of vehicle deceleration.

A hybrid vehicle 1 of another embodiment (not shown) according to the present disclosure comprises an electric motor mechanically coupled to an axle, a generator, and an internal combustion engine. In the other embodiment, the output of the internal combustion engine is not used to drive the vehicle and is used to drive the generator. Electric power generated by the generator is used to drive the electric motor, and the output of the electric motor is used for driving the vehicle.

In the embodiments according to the present disclosure, the electric motor 3 and the generator 4 are electrically connected to the battery 9 via the power control unit 8. The power control unit 8 includes, for example, an inverter for converting current from direct current to alternating current or vice versa, a converter for regulating the voltage, and the like. When it is necessary that the electric motor 3 be operated, one or both of the power generated by the generator 4 and the power stored in the battery 9 is supplied to the electric motor 3 via the power control unit 8. Conversely, the power generated by the generator 4 and the power generated by the electric motor 3 which has operated as a generator are supplied via the power control unit 8 to the battery 9, and stored therein.

The upstream catalyst 30u of the embodiment according to the present disclosure is composed of an electrically heated catalyst (EHC). The upstream catalyst 30u of the embodiment according to the present disclosure is provided with a conductive carrier having a pair of electrodes 30ue, and the carrier is energized to generate heat to thereby increase the temperature of the catalyst supported on the carrier. When the upstream catalyst 30u is required to be energized, the electric power stored in the battery 9 is supplied to the upstream catalyst 30u via the power control unit 8. In another embodiment (not shown), the upstream catalyst 30u is provided with an electric heater separate from the carrier, and the temperature of the upstream catalyst 30u is increased when the electric heater is energized. In yet another embodiment (not shown), the upstream catalyst 30u includes a microwave generator (not shown), and when the microwave generator is energized to irradiate the upstream catalyst 30u with microwaves so that the upstream catalyst 30u is increased in temperature. Note that the downstream catalyst 30d of the embodiment according to the present disclosure is composed of a catalyst which is not of an electrically heated catalyst. In another embodiment (not shown), the upstream catalyst 30u is composed of a catalyst that is not of an electrically heated catalyst, and the downstream catalyst 30d is composed of an electrically heated catalyst.

The electronic control unit 40 of the embodiment according to the present disclosure includes one or more processors 42, one or more memories 43, and an input/output port 44 which are communicatively connected to each other by a bi-directional bus 41. One or more sensors 45 and a warning device 46 are communicatively connected to the input/output port 44. Various programs are stored in the memory 43, and various routines are executed by executing these programs in the processor 42. The sensor 45 of the embodiment according to the present disclosure includes, for example, a depression amount sensor for detecting a depression amount of an accelerator pedal (not shown) representing a vehicle request output, a crank angle sensor for detecting a crank angle of the internal combustion engine 2, an air flow meter for detecting an amount of intake air of the internal combustion engine 2, a voltmeter and an ammeter for detecting a voltage and a current between terminals of the battery 9, a battery temperature sensor for detecting a temperature of the battery 9, and the like. In the processor 42 of the embodiment according to the present disclosure, for example, the rotational speed of the internal combustion engine 2 is calculated based on the output of the crank angle sensor, and the SOC (state of charge) of the battery 9 is calculated based on the outputs of the voltmeter, the ammeter, and the battery temperature sensor. The input/output port 44 is communicatively connected to the electric motor 3, the generator 4, the power dividing mechanism 5, the power control unit 8, the fuel injector 22, the spark plug 23, and the throttle valve 26, and the warning device 46. The electric motor 3, etc., are controlled based on a signal from the electronic control unit 40. The warning device 46 of the embodiment according to the present disclosure provides the occupant of the hybrid vehicle 1 with an audible alarm (such as a buzzer), a visual alarm (such as a lamp), or a tactile alarm (such as a vibration device).

When the exhaust gas flowing into the catalyst 30 or the upstream catalyst 30u is referred to as an inflow exhaust gas and the exhaust gas flowing out of the catalyst 30 or the downstream catalyst 30d is referred to as an outflow exhaust gas, in the embodiment according to the present disclosure, an inflow exhaust gas detector 47i configured to detect the state quantity of the inflow exhaust gas and an outflow exhaust gas detector 47o configured to detect the state quantity of the outflow exhaust gas are further provided. The inflow exhaust gas detector 47i of the embodiment according to the present disclosure includes an inflow exhaust gas sensor 47i attached to the exhaust pipe 28, and detects the state quantity of the inflow exhaust gas by the inflow exhaust gas sensor 47i. The inflow exhaust gas detector 47i of another embodiment (not shown) estimates the state quantity of the inflow exhaust gas, using a calculation model, for example, based on the engine operating state. Further, the outflow exhaust gas detector 47o of the embodiment according to the present disclosure includes an outflow exhaust gas sensor 47o attached to the exhaust pipe 31, and detects the state quantity of the outflow exhaust gas by the outflow exhaust gas sensor 47o. The outflow exhaust gas detector 47o of another embodiment (not shown) estimates the state quantity of the outflow exhaust gas, using a calculation model, for example, based on the engine operating state.

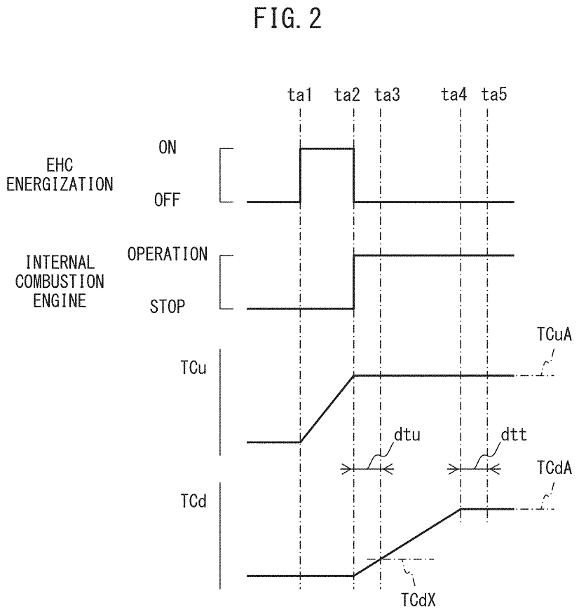

Referring to FIG. 2, an engine start control of an embodiment according to the present disclosure will be described. In FIG. 2, ta1 indicates the time when it is determined that the operation of the internal combustion engine 2 should be started. In the embodiment of the present disclosure, at the time ta1, energization of the upstream catalyst (EHC) 30u is started while the internal combustion engine 2 is kept stopped. In this case, since the internal combustion engine 2 is stopped, there is no gas flow from the upstream catalyst 30u toward the downstream catalyst 30d. In addition, in the embodiment according to the present disclosure, the upstream catalyst 30u and the downstream catalyst 30d are spaced apart from each other. As a result, the temperature TCu of the upstream catalyst 30u rapidly increases without no substantial increase in the temperature TCd of the downstream catalyst 30d.

When the temperature TCu of the upstream catalyst 30u reaches its activation temperature TCuA at the time ta2, i.e., when the upstream catalyst 30u enters the active state, in the embodiment according to the present disclosure, the energization of the upstream catalyst (EHC) 30u is stopped. In the embodiment according to the present disclosure, the amount of electric power required to make the temperature TCu of the upstream catalyst 30u equal to or higher than the activation temperature TCuA, i.e., the required amount of electric power, is calculated, and when the required amount of electric power is supplied to the upstream catalyst 30u, the energization of the upstream catalyst 30u is stopped. In the embodiment according to the present disclosure, when the upstream catalyst 30u enters the active state, the operation or combustion of the internal combustion engine 2 is started. In accordance with the above, when the upstream catalyst 30u is in the inactive state, exhaust gas is not discharged from the internal combustion engine 2, and thus, unpurified exhaust gas is prevented from being discharged into the atmosphere. Further, since the operation of the internal combustion engine 2 is started after the upstream catalyst 30u enters the active state, the exhaust gas of the internal combustion engine 2 is reliably purified by the upstream catalyst 30u.

When the operation of the internal combustion engine 2 is started, relatively high-temperature exhaust gas flows into the downstream catalyst 30d. In addition, unburned HC or the like in the exhaust gas is oxidized or purified by the upstream catalyst 30u, the exhaust gas is heated by the reaction heat, and the heated exhaust gas flows into the downstream catalyst 30d. As a result, the temperature TCd of the downstream catalyst 30d is increased while the upstream catalyst 30u is maintained in the active state. In the example shown in FIG. 2, the temperature TCd of the downstream catalyst 30d reaches its activation temperature TCdA at the subsequent time ta4, and the downstream catalyst 30d enters the active state.

In this manner, in the embodiment according to the present disclosure, from the time ta2 to the time ta4 shown in FIG. 2, the upstream catalyst 30u is in the active state and the downstream catalyst 30d is in the inactive state. Conversely, after the time ta4, both the upstream catalyst 30u and the downstream catalyst 30d are in the active state.

In the embodiment according to the present disclosure, the state quantity of the exhaust gas is represented by the air-fuel ratio of the exhaust gas. Therefore, the inflow exhaust gas sensor 47i is composed of an inflow air-fuel ratio sensor for detecting the air-fuel ratio of the inflow exhaust gas, and the outflow exhaust gas sensor 47o is composed of an outflow air-fuel ratio sensor for detecting the air-fuel ratio of the outflow exhaust gas. The inflow air-fuel ratio sensor 47i of the embodiment according to the present disclosure comprises an air-fuel ratio sensor of so-called linear characteristics. Conversely, the outflow air-fuel ratio sensor 47o of the embodiment according to the present disclosure comprises an air-fuel ratio sensor of so-called linear characteristics or an air-fuel ratio sensor of so-called Z characteristics. The air-fuel ratio sensor of linear characteristics generates an output voltage which has a one-to-one relationship with the air-fuel ratio of exhaust gas in a wide air-fuel ratio range. In contrast, the air-fuel ratio sensor of Z characteristics outputs a substantially constant high voltage regardless of the air-fuel ratio when the air-fuel ratio is rich, and outputs a substantially constant low voltage regardless of the air-fuel ratio when the air-fuel ratio is lean.

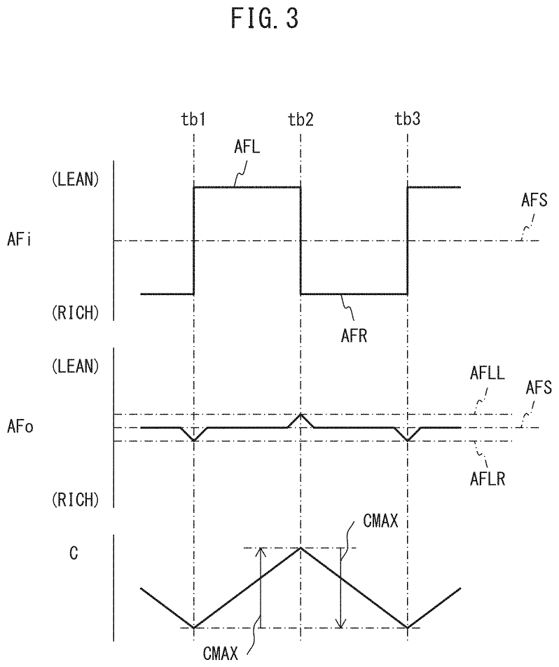

In the embodiment of the present disclosure, the maximum oxygen storage amount CMAX of the catalyst 30 is detected based on the output of the inflow air-fuel ratio sensor 47i and the output of the outflow air-fuel ratio sensor 47o. This will be explained with reference to FIG. 3.

In the example shown in FIG. 3, at the time tb1, in order to make the air-fuel ratio AFi of the inflow exhaust gas a lean air-fuel ratio AFL larger than the stoichiometric air-fuel ratio AFS, based on the output of the inflow air-fuel ratio sensor 47i, for example, the air-fuel ratio in the combustion chamber is switched and held. In this case, excess oxygen in the exhaust gas is stored in the catalyst 30. As a result, the oxygen storage amount C of the catalyst 30 gradually increases. Note that the oxygen storage amount C is calculated by cumulatively adding an increment determined according to the air-fuel ratio AFi of the inflowing exhaust gas. During a period where oxygen is stored in the catalyst 30, the air-fuel ratio AFo of the outflow exhaust gas is almost maintained at the stoichiometric air-fuel ratio AFS. Next, when the oxygen storage amount of the catalyst 30 reaches the maximum amount, i.e., when oxygen is not stored any more in the catalyst 30, the air-fuel ratio AFo of the outflow exhaust gas becomes leaner than the stoichiometric air-fuel ratio AFS.

In the example shown in FIG. 3, when the air-fuel ratio AF0 of the outflow exhaust gas at the time tb2 exceeds the predetermined limit lean air-fuel ratio AFLL, in order to make the air-fuel ratio AFi of the inflow exhaust gas a rich air-fuel ratio AFR smaller than the stoichiometric air-fuel ratio AFS, based on the output of the inflow air-fuel ratio sensor 47i, for example, the air-fuel ratio in the combustion chamber is switched and held. In this case, oxygen is released from the catalyst 30, and this oxygen is used to oxidize HC and CO in the exhaust gas. As a result, the oxygen storage amount C of the catalyst 30 gradually decreases. Note that the oxygen storage amount C is calculated by cumulatively adding a decrement determined in accordance with the air-fuel ratio AFi of the inflowing exhaust gas. While oxygen is being discharged from the catalyst 30, the air-fuel ratio AFo of the outflowing exhaust gas is maintained substantially at the stoichiometric air-fuel ratio AFS. Next, when the oxygen storage amount of the catalyst 30 reaches zero, i.e., when oxygen is not released from the catalyst 30, the air-fuel ratio AFo of the outflow exhaust gas becomes richer than the stoichiometric air-fuel ratio AFS.

In the example shown in FIG. 3, when the air-fuel ratio AF0 of the outflow exhaust gas at the time tb1 or tb3 lowers beyond a predetermined limit-rich air-fuel ratio AFLR, the air-fuel ratio AFi of the inflow exhaust gas is returned to the lean air-fuel ratio AFR.

Thus, in the embodiment according to the present disclosure, based on the output of the inflow air-fuel ratio sensor 47i and the output of the outflow air-fuel ratio sensor 47o, the air-fuel ratio AFi of the inflow exhaust gas is repeatedly switched between the lean air-fuel ratio AFL and the rich air-fuel ratio AFR. In this case, the increase in the oxygen storage amount C of the catalyst 30 in the period from when the air-fuel ratio AFi of the inflow exhaust gas is switched to the lean air-fuel ratio AFL to when it is switched to the rich air-fuel ratio AFR, or the decrease in the oxygen storage amount C of the catalyst 30 in the period from when the air-fuel ratio AFi of the inflow exhaust gas is switched to the rich air-fuel ratio AFR to when it is switched to the lean air-fuel ratio AFL, represents the maximum oxygen storage amount or oxygen storage capacity CMAX of the catalyst 30.

The maximum oxygen storage amount CMAX of the catalyst 30 represents the degree of deterioration of the catalyst 30. Specifically, when the maximum oxygen storage amount CMAX of the catalyst 30 is large, the degree of catalyst deterioration is small, and when the maximum oxygen storage amount CMAX of the catalyst 30 is small, the degree of catalyst deterioration is large. Therefore, in the embodiment according to the present disclosure, the degree of deterioration of the catalyst 30 is detected based on the outputs of the inflow air-fuel ratio sensor 47i and the outflow air-fuel ratio sensor 47o.

In an embodiment according to the present disclosure, the maximum oxygen storage amount CMAX of the catalyst 30 is detected when both the upstream catalyst 30u and the downstream catalyst 30d are in an active state. In one instance, the maximum oxygen storage amount CMAX of the catalyst 30 is detected in the time period dtt from the time ta4 to the time ta5 shown in FIG. 2.

When both the upstream catalyst 30u and the downstream catalyst 30d are in the active state, the output of the outflow air-fuel ratio sensor 47o is affected by the deterioration of the upstream catalyst 30u and the deterioration of the downstream catalyst 30d. Therefore, the maximum oxygen storage amount CMAX of the catalyst 30 detected when both the upstream catalyst 30u and the downstream catalyst 30d are in the active state represents the total CMAXt of the maximum oxygen storage amount CMAXu of the upstream catalyst 30u and the maximum oxygen storage amount CMAXd of the downstream catalyst 30d. In this case, the total CMAXt of the maximum oxygen storage amount represents the degree of deterioration of the upstream catalyst 30u and the downstream catalyst 30d as a whole.

In addition, in the embodiment according to the present disclosure, the maximum oxygen storage amount CMAX of the catalyst 30 is detected when the upstream catalyst 30u is in an active state and the downstream catalyst 30d is in an inactive state. In one instance, the maximum oxygen storage amount CMAX of the catalyst 30 is detected in the time period dtu from the time ta2 to the time ta3 shown in FIG. 2. In the embodiment shown in FIG. 2, the time ta3 is a time when the temperature TCd of the downstream catalyst 30d reaches a predetermined threshold temperature TCdx (<TCdA). In another instance, the maximum oxygen storage amount CMAX of the catalyst 30 is detected in the time period from the time ta2 to the time ta4 shown in FIG. 2.

When the upstream catalyst 30u is in the active state and the downstream catalyst 30d is in the inactive state, the output of the outflow exhaust gas sensor 47o is affected by the deterioration of the upstream catalyst 30u, but is not affected by the deterioration of the downstream catalyst 30d. The maximum oxygen storage amount CMAX of the catalyst 30 detected when the upstream catalyst 30u is in the active state and the downstream catalyst 30d is in the inactive state represents the maximum oxygen storage amount CMAXu of the upstream catalyst 30u.

Thus, in the embodiment according to the present disclosure, the total CMAXt of the maximum oxygen storage amount and the maximum oxygen storage amount CMAXu of the upstream catalyst 30u are detected. In the embodiment according to the present disclosure, further, the maximum oxygen storage amount CMAXd of the downstream catalyst 30d is calculated using the following formula.

CMAXd=CMAXt−CMAXu

Therefore, in the embodiment according to the present disclosure, it is possible to detect the degree of deterioration of the upstream catalyst 30u with a simple configuration. Further, it is also possible to detect the degree of deterioration of the downstream catalyst 30d with a simple configuration. In other words, it is possible to individually detect the degree of deterioration of the upstream catalyst 30u and the degree of deterioration of the downstream catalyst 30d.

In an embodiment according to the present disclosure, it is further determined whether or not the maximum oxygen storage amount CMAXu of the upstream catalyst 30u is less than a predetermined threshold CMAXuX. When CMAXu<CMAXuX, the warning device 46 alerts the occupant of the hybrid vehicle 1 that the degree of deterioration of the upstream catalyst 30u is large. In addition, in the embodiment according to the present disclosure, it is determined whether or not the maximum oxygen storage amount CMAXd of the downstream catalyst 30d is smaller than a predetermined threshold value CMAXdX. When CMAXd<CMAXdX, the warning device 46 wams the occupant that the degree of deterioration of the downstream catalyst 30d is large.

In the embodiment according to the present disclosure, the temperature TCu of the upstream catalyst 30u is estimated using a calculation model, for example, based on the engine operating state. In another embodiment (not shown), the temperature TCu of the upstream catalyst 30u is detected by a temperature sensor for directly detecting the temperature of the upstream catalyst 30u, or by a temperature sensor for detecting the temperature of the exhaust gas flowing into the upstream catalyst 30u or the temperature of the exhaust gas flowing from the upstream catalyst 30u. Further, in the embodiment according to the present disclosure, the temperature TCd of the downstream catalyst 30d is estimated using a calculation model, for example, based on the engine operating state. In another embodiment (not shown), the temperature TCd of the downstream catalyst 30d is detected by a temperature sensor for directly detecting the temperature of the downstream catalyst 30d or by a temperature sensor for detecting the temperature of the exhaust gas flowing into the downstream catalyst 30d or the temperature of the exhaust gas flowing out of the downstream catalyst 30d.

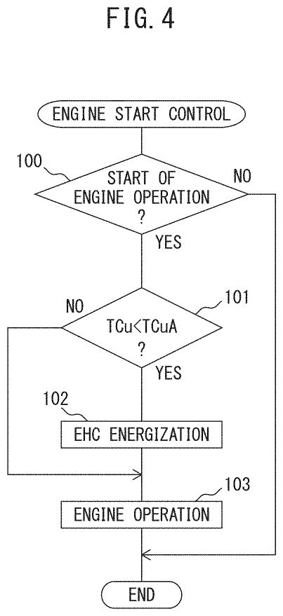

FIG. 4 illustrates the engine start control routine of an embodiment according to the present disclosure. This routine is executed by the processor 42 executing a program stored in the memory 43. Referring to FIG. 4, it is determined in step 100 whether or not the operation of the internal combustion engine 2 should be started. When the operation of the internal combustion engine 2 should not be started, the processing cycle is terminated. When the operation of the internal combustion engine 2 should be started, the routine then proceeds to step 101, and it is determined whether the temperature TCu of the upstream catalyst 30u is lower than its activation temperature TCuA. When TCu<TCuA, i.e., when the upstream catalyst 30u is inactive, the routine proceeds to step 102 where the upstream catalyst (EHC) 30u is energized. In an embodiment according to the present disclosure, the upstream catalyst 30u is energized by the amount of power required to activate the upstream catalyst 30u. As a result, the upstream catalyst 30u is brought into an active state. Next, the routine proceeds to step 103. Conversely, when TCu TCuA, i.e., when the upstream catalyst 30u is active, the routine skips from step 101 to step 103. In step 103, the operation of the internal combustion engine 2 is started.

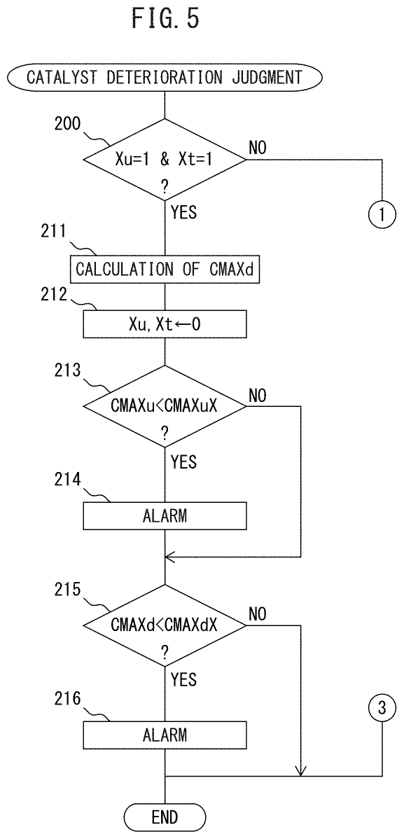

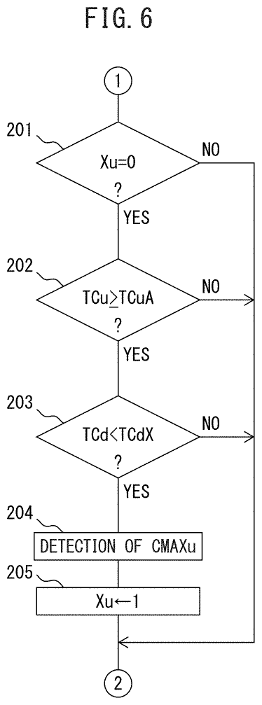

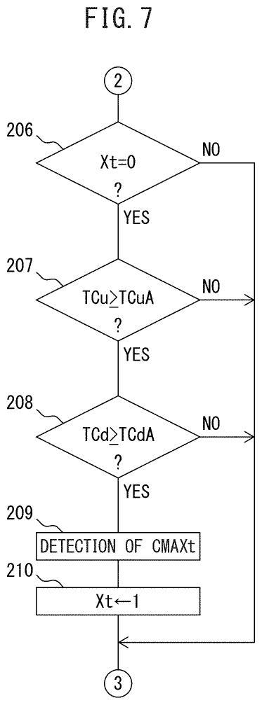

FIGS. 5 to 7 illustrate the catalyst deterioration determination routine of an embodiment according to the present disclosure. Referring to FIGS. 5 to 7, in step 200, it is determined whether or not both a flag Xu and a flag Xt are set. This flag Xu is set (Xu=1) when the maximum oxygen storage amount CMAXu of the upstream catalyst 30u is detected, and is reset (Xu=0) when the maximum oxygen storage amount CMAXd of the downstream catalyst 30d is detected. Conversely, the flag Xt is set (Xt=1) when the total CMAXt of the maximum oxygen storage amount, i.e., the sum of the maximum oxygen storage amount CMAXu of the upstream catalyst 30u and the maximum oxygen storage amount CMAXd of the downstream catalyst 30d is detected, and is reset (Xt=0) when the maximum oxygen storage amount CMAXd of the downstream catalyst 30d is detected. If both the flag Xu and the flag Xt are not set, the routine proceeds from step 200 to step 201 where it is determined whether the flag Xu is reset. When the flag Xu is reset, the routine then proceeds to step 202 where it is determined whether or not the temperature TCu of the upstream catalyst 30u is equal to or higher than the activation temperature TCuA. When TCu≥TCuA, the routine proceeds to step 203 where it is determined whether or not the temperature TCd of the downstream catalyst 30d is lower than a predetermined threshold temperature TCdX(<TCdA). When TCd<TCdX, the routine then proceeds to step 204 where the maximum oxygen storage amount CMAXu of the upstream catalyst 30u is detected. In the following step 205, the flag Xu is set. The routine then proceeds to step 206. Conversely, when the flag Xu is reset in step 201, when TCu<TCuA in step 202, or when TCd≥TCdX in step 203, the routine skips to step 206.

In step 206, it is determined whether the flag Xt is reset. When the flag Xt is reset, the routine proceeds from step 206 to step 207 where it is determined whether or not the temperature TCu of the upstream catalyst 30u is equal to or higher than the activation temperature TCuA. When TCu≥TCuA, the routine proceeds to step 208 where it is determined whether or not the temperature TCd of the downstream catalyst 30d is greater than or equal to its activation temperature TCdA. When TCd≥TCdA, the routine then proceeds to step 209 where the maximum oxygen storage amount CMAXt of catalyst 30 is detected. The flag Xt is set in the subsequent step 210. The processing cycle is then terminated. Conversely, when the flag Xt is set in step 206, when TCu<TCuA in step 207, or when TCd<TCdA in step 208, the processing cycle ends.

When both the flag Xu and the flag Xt are set, the routine proceeds from step 200 to step 211, and the maximum oxygen storage amount CMAXd of the downstream catalyst 30d is calculated (CMAXd=CMAXt−CMAXu). In the following step 212, the flags Xu and Xt are reset, respectively.

In step 213, it is determined whether or not the maximum oxygen storage amount CMAXu of the upstream catalyst 30u is smaller than a predetermined threshold CMAXuX. If CMAXu<CMAXuX, the routine proceeds to step 214, and the occupant is warned by the warning device 46 that the degree of deterioration of the upstream catalyst 30u is large. The routine then proceeds to step 215. Conversely, if CMAXu≥CMAXuX, the routine skips to step 215. In step 215, it is determined whether or not the maximum oxygen storage amount CMAXd of the downstream catalyst 30d is smaller than a predetermined threshold CMAXdX. If CMAXd<CMAXdX, the routine proceeds to step 216 where the warning device 46 wams the occupant that the downstream catalyst 30d has a large degree of deterioration. The processing cycle is then terminated. Conversely, if CMAXd≥CMAXdX, the processing cycle is terminated.

In the embodiment according to the present disclosure described above, the state quantity of the inflow exhaust gas is represented by the air-fuel ratio of the inflow exhaust gas, and the state quantity of the outflow exhaust gas is represented by the air-fuel ratio of the outflow exhaust gas. Conversely, in another embodiment (not shown), the state quantity of the inflow exhaust gas is represented by the concentration or quantity of the specific component in the inflow exhaust gas, and the state quantity of the outflow exhaust gas is represented by the concentration or quantity of a specific component in the inflow exhaust gas. In one example, the specific component is NOx.

The present application claims the benefit of Japanese Patent Application No. 2020-004531, the entire disclosure of which is incorporated by reference herein.

### REFERENCE SIGNS LIST

1. hybrid vehicle
2. internal combustion engine
28. exhaust pipe
30u. upstream catalyst
30d. downstream catalyst
40. electronic control unit
47i. inflow exhaust gas detector
47o. outflow exhaust gas detector

1. A catalyst deterioration judging device for an internal combustion engine, comprising:
a catalyst including a first catalyst and a second catalyst arranged in series in an engine exhaust passage;
an inflow exhaust gas detector configured to detect a state quantity of an inflow exhaust gas to the catalyst;
an outflow exhaust gas detector configured to detect a state quantity of an outflow exhaust gas from the catalyst; and
an electronic control unit configured to detect a degree of deterioration of the first catalyst based on an output of the inflow exhaust gas detector and an output of the outflow exhaust gas detector when the first catalyst is in an active state and the second catalyst is in an inactive state.

2. The catalyst deterioration judging device for an internal combustion engine according to claim 1, wherein
the first catalyst is comprised of a catalyst that can be activated when the internal combustion engine is stopped, and
the electronic control unit is further configured to activate the first catalyst while maintaining the internal combustion engine stopped, to thereby make the first catalyst in the active state and the second catalyst in the inactive state.

3. The catalyst deterioration judging device for an internal combustion engine according to claim 1, wherein
the first catalyst is comprised of an electrically heated catalyst, and
the electronic control unit is further configured to energize the first catalyst while maintaining the internal combustion engine stopped, to thereby make the first catalyst in the active state and the second catalyst in the inactive state.

4. The catalyst deterioration judging device for an internal combustion engine according to claim 1, wherein
the first catalyst has an oxygen storage capacity,
the inflow exhaust gas detector is configured to detect an air-fuel ratio of the inflow exhaust gas, and
the outflow exhaust gas detector is configured to detect an air-fuel ratio of the outflow exhaust gas.

5. The catalyst deterioration judging device for an internal combustion engine according to claim 1, wherein
the electronic control unit is further configured to:
detect the degree of deterioration of the catalyst as a whole based on the output of the inflow exhaust gas detector and the output of the outflow exhaust gas detector when the first catalyst is in the active state and the second catalyst is in the active state; and
detect the degree of deterioration of the second catalyst based on the degree of deterioration of the first catalyst and the degree of deterioration of the catalyst as a whole.

6. The catalyst deterioration judging device for an internal combustion engine according to claim 5, wherein
the first catalyst is comprised of a catalyst that can be activated when the internal combustion engine is stopped, and
the electronic control unit is further configured to activate the first catalyst while maintaining the internal combustion engine stopped, to thereby make the first catalyst in the active state and the second catalyst in the inactive state.

7. The catalyst deterioration judging device for an internal combustion engine according to claim 5, wherein
the first catalyst is comprised of an electrically heated catalyst, and
the electronic control unit is further configured to:
energize the first catalyst while maintaining the internal combustion engine stopped, to thereby make the first catalyst in the active state and the second catalyst in the inactive state; and
operate the internal combustion engine, to thereby make the first catalyst in the active state and the second catalyst in an active state.

8. The catalyst deterioration judging device for an internal combustion engine according to claim 5, wherein
the first catalyst and the second catalyst have an oxygen storage capacity,
the inflow exhaust gas detector is configured to detect an air-fuel ratio of the inflow exhaust gas, and
the outflow exhaust gas detector is configured to detect an air-fuel ratio of the outflow exhaust gas.

9. The catalyst deterioration judging device for an internal combustion engine according to claim 1, wherein the first catalyst is disposed on an upstream side in an exhaust gas flow direction, and the second catalyst is disposed on a downstream side in the exhaust gas flow direction.

10. The catalyst deterioration judging device for an internal combustion engine according to claim 1, wherein the electronic control unit is further configured, when the operation of the internal combustion engine is to be started, to first activate the first catalyst while maintaining the internal combustion engine stopped, and then start the operation of the internal combustion engine after the first catalyst is activated.

11. A catalyst deterioration judging method of an internal combustion engine which is provided with a catalyst including a first catalyst and a second catalyst arranged in series in an engine exhaust passage, the catalyst deterioration judging method comprising:
detecting a state quantity of an inflow exhaust gas flowing into the catalyst;
detecting a state quantity of an outflow exhaust gas flowing out from the catalyst; and
detecting a degree of deterioration of the first catalyst based on the state quantity of the inflow exhaust gas and the state quantity of the outflow exhaust gas when the first catalyst is in an active state and the second catalyst is in an inactive state.

12. The catalyst deterioration judging method of an internal combustion engine according to claim 11, wherein
the first catalyst is comprised of a catalyst that can be activated when the internal combustion engine is stopped, and
the method comprises activating the first catalyst while maintaining the internal combustion engine stopped, to thereby make the first catalyst in the active state and the second catalyst in the inactive state.

13. The catalyst deterioration judging method of an internal combustion engine according to claim 11, wherein
the first catalyst is comprised of an electrically heated catalyst, and
the method comprises energizing the first catalyst while maintaining the internal combustion engine stopped, to thereby make the first catalyst in the active state and the second catalyst in the inactive state.

14. The catalyst deterioration judging method of an internal combustion engine according to claim 11, comprising:
detecting the degree of deterioration of the catalyst as a whole based on the state quantity of the inflow exhaust gas and the state quantity of the outflow exhaust gas when the first catalyst is in the active state and the second catalyst is in the active state; and
detecting the degree of deterioration of the second catalyst based on the degree of deterioration of the first catalyst and the degree of deterioration of the catalyst as a whole.
